(19) United States
(12) Patent Application Publication
(10) Pub. No.: US 2008/0132411 A1
(43) Pub. Date: Jun. 5, 2008

(54) Process for coating seeds with microorganism inoculants

(75) Inventors: Simon James Watt, Taverham (GB); Richard Walker, King's Lynn (GB)

Correspondence Address: VINSON & ELKINS L.L.P., 1001 FANNIN STREET, 2300 FIRST CITY TOWER, HOUSTON, TX, 77002-6760, US

(73) Assignee: Germains Technology Group, Kings Lynn (GB)

(21) Appl. No.: 11/607,647

(22) Filed: Dec. 1, 2006

(51) Int. Cl. A01N 25/26

(52) U.S. Cl. 504/100

(57) ABSTRACT

A method for improving the survival and viability of microorganism inoculants on the seeds, comprising the step of coating seeds with a mixture comprising a carbohydrate, a sugar alcohol and microorganisms. Also described are the mixture used in the foregoing method, a kit comprised of an aqueous mixture of a carbohydrate and a sugar alcohol and an aqueous mixture of microorganisms as well as planting seeds with such coating applied. This invention is directed to all types of planting seed and a wide range of microorganism inoculants. Preparation of sterile liquid formulation of the novel mixture is described. The mixture is also biodegradable, which is environmentally advantageous.

### BACKGROUND OF THE INVENTION

1. Field of the Invention

The present invention relates to a method of formulating and producing a mixture for coating agricultural seed for sowing crops with living microorganism inoculants, and a method for improving the survival and viability of microorganism inoculants on the seeds.

2. Description of the Related Art

A wide range of microorganisms are beneficial to plants in many different ways. Beneficial microorganisms can include diverse fungi and bacteria as well as nematodes and protozoan organisms. Some microorganisms are beneficial in that they increase the amounts of available nitrogen or phosphorous in the soil surrounding the plants. Others decompose organic materials in the soil, thereby releasing plant nutrients, while other microorganisms assist by regulating the numbers or activities of potentially harmful organisms that may be present in the vicinity of the plants. Still other microorganisms help plants by fixing nitrogen from the atmosphere, e.g., combining the nitrogen chemically with other elements to form more reactive nitrogen compounds, such as ammonia, nitrates, or nitrates. This latter group of microorganisms includes bacteria which form a symbiotic relationship with leguminous plants. These bacteria, often referred to as rhizobia, fix atmospheric nitrogen (N₂) when associated with leguminous plants by forming root nodules, thus providing the host plant with most or all of its nitrogen requirements and reducing the need for nitrogen fertilizer. A degree of specificity exists between the partner species in the N₂-fixing symbiotic relationship. Species of Rhizobium and those in the closely related genera of Mesorhizobium, Sinorhizobium or Bradyrhizobium all are associated with leguminous plants, such as Mesorhizobium loti on species of Lotus species; Sinorhizobium fredii on Glycine max (soybean), Sinorhizobium meliloti on Medicago species, Melilotus species and Trigonella species; Bradyrhizobium japonicum on Glycine max and Vigna unguiculata (cowpea).

Although rhizobia can survive saprophytically in the soil, many soils lack or contain only low numbers of indigenous rhizobia. Furthermore, these indigenous rhizobia may be only moderately effective in symbiotic nitrogen fixation. In these cases, it is a well-established practice to apply highly effective strains of rhizobia as inoculants so as to ensure optimum crop yields (see for example, European Patent No. 0454291).

In most countries where legume inoculation is a common practice, the regulatory authorities set minimum standards of rhizobial concentration and acceptable levels of contamination. In Canada, for example, soybean inoculants must deliver 10⁵ viable rhizobia per seed at the time of planting, whereas the French authorities stipulate 10⁶ per seed.

In addition to rhizobia, other microorganisms may also be applied as beneficial inoculants on seeds. Some of these microorganisms include plant growth promoting microorganisms and biocontrol agents, examples include microorganism strains from the bacterial genera Pseudomonas, Serratia, Bacillus, Azotobacter, Enterobacter, Azospirillum and Burkholderia, as well as actinomycetes such as Streptomyces, and even cyanobacteria. Fungal genera such as Gliocladium, Trichoderma, Coniothyrium, and Verticillium may also be applied as inoculants (see McQuilken, M P, Halmer P and Rhodes, D. J, 1998, Application of Microorganisms to Seeds; In Formulation of Microorganism Biopesticides: Beneficial microorganisms, nematodes and seed treatments, Ed. H. D. Burges, Kluwer Academic Publishers, pp 255-285; Whipps, J. M. 1997, Developments in the biological control of soil-borne plant pathogens, Advances in Botanical Research 26, 1-134).

Even though it is a well-established practice, the technology of applying inoculants to seeds is widely varied. At present, for large-seeded legumes, in most countries, inoculants are mixed with seed on-farm; the farmer mixes the inoculant and the seed together—by hand, or batch mixing—just before or during its loading into planting equipment. The general recommendation is that such a seed is planted within a few hours of inoculation. The production of such an inoculated seed presents an extra step for the farmer and contributes to the complexity and uncertainty of the farming process.

One impediment to delivering pre-inoculated seed technology is the natural instability of microorganisms. Some microorganisms are unable to survive the abrupt drying process when inoculated onto seeds or any further periods of open air storage. In general, bacterial or fungal species that have a resting stage in their life cycle (such as resistant spores or other propagules) are easier to apply to seeds in this way. Species and strains, including gram-negative bacteria such as rhizobia, that do not form natural resting structures, generally cannot withstand the rapid drying without a large proportion of the inoculant population dying. These microorganisms sometimes continue to die during subsequent storage time in the air. For example, the number of rhizobia on pre-inoculated seeds tends to decline further during subsequent air storage in many legume-rhizobial combinations, notably in Glycine max (soybean)-Bradyrhizobium japonicum combination. By comparison, the symbiotic rhizobia for some other crops, are naturally more resilient to a pre-inoculation process. For example, in Europe, North America and elsewhere, Medicago sativa (alfalfa) seed is commonly coated with mixtures of peat-based or clay-based inoculants, and manufacturers claim adequate numbers of viable rhizobial cells can be maintained for 12 to 18 months by various processes, including by seed encrusting techniques with adhesive and finely ground lime (CaCO₃); however, these claims have been disputed. See U.S. Pat. No. 5,106,648.

A common partial remedy for post-inoculation losses of rhizobia on seeds is to apply at least a ten-fold, and typically a hundred-fold, excess of the final amount of rhizobia required at the point of inoculation. However, because of the moisture level that must be maintained during seed storage in order to prolong seed viability, the number of viable rhizobia remaining on the seed can rapidly fall below the threshold necessary to help the nodulation process. This results in nodulation failures when the pre-inoculated seeds are sown.

Furthermore, it is commonplace for seeds of many crops to be pre-treated with crop protection chemicals such as fungicides and insecticides. These materials are usually applied some time before seed sowing. Hence, when seeds are pre- or co-inoculated with crop protection chemicals, which are sometimes potentially toxic agrochemicals, rhizobial survival may be further reduced.

The industry continues to look for new methods both to simplify the on-farm procedure and to enable seeds to be treated with microorganisms ahead of time without great loss of effectiveness. Ideally, these improvements would combine the convenience of preparing pre-inoculated seed without the need for planter-box applications. The industry is looking for pre-inoculed formulations that are easy to apply and yet allow microorganisms, like rhizobial cells, to survive on the seed for several months prior to being planted. These inoculated seeds should have a survival and/or viability of at least one month, and ideally three or more months, at ambient temperature in order to allow seed distributors and growers greater flexibility in planting while still maintaining the benefits of microorganism inoculants.

Currently, there are seed coating products made from a carrier, a beneficial micro-organism and a compatible adhesive polymer of vinyl copolymers, as shown in U.S. Pat. No. 5,106,648. This required carrier in these products is usually peat, clay, silt or the like.

Others have also made seed coating products with a biodegradable, water-retaining film-forming polymer, such as a chitosan, an alginate, a cellulose or one of their derivatives, selected according to the type of exopolysaccharide produced by the bacterial innoculum, and an agent, such as L-glutamic acid, for rapidly increasing the intracellular osmotic pressure of the bacteria, as seen in WO98/30077.

U.S. Pat. No. 5,916,029 teaches a process of coating seeds that adds carbohydrates, including starch, as stabilization additives when inoculating seeds with dried, dormant microorganisms. However, the coating and drying steps must be conducted so that the microorganisms are moistened for a sufficient time to form the coated seeds, but with a total water exposure period of no more than about 12 hours.

These methods all use solid rhizobial inoculant formulations. Solid carrier-based rhizobial inoculant formulations include those that are peat-based in sterilized sachets to eliminate non-rhizobial contaminants. Others contain polymers which not only enhance adhesion, but also extend the on-seed survival of the rhizobial cells, thereby extending the planting window for farmers from a few hours post inoculation to 2-3 days. However, all of these methods still require seeds to be treated no more than a few days before sowing. An alternative approach for increasing the survival of inoculant composition is to incubate a culture containing the microorganism with a clay carrier, such as described in U.S. Pat. No. 5,695,541.

A recent approach for preparing pre-inoculated seeds with a longer survival uses a gel or a liquid bio-matrix and inert compounds to form a solid biodegradable pellet, which is then applied to seeds after dissolution in water, as described in U.S. Patent Application No. 2004/0022860. Alternatively, partially cross-linked polymer gel matrix, including polysaccharides, such as that disclosed in U.S. Pat. No. 5,021,350, can be used to coat the seeds. Still other coating compounds consist of a wettable powder, in which a lyophilized preparation is mixed with substances rich in polysaccharides, such as that described by PCT application WO94/06732. This wettable powder, however, requires the farmer to mix the inoculant with the seeds slightly prior to sowing. These mixtures generally are not as convenient to use as liquid inoculants.

Recently, sterile liquid rhizobial inoculant formulations have been commercially developed for seed application. Advantages of the liquid inoculants include the greater quantity of bacteria contained in the inoculants and practical convenience of use.

### SUMMARY OF THE INVENTION

This present invention provides a novel seed-coating aqueous mixture that includes a microorganism inoculant and method for improving the survival and viability of microorganism inoculants on seed by coating the seed with an aqueous mixture containing such microorganism inoculants. This invention extends the survival and viability of non spore-forming microorganism inoculants during air storage post-inoculation onto seeds. The invention increases survival and viability of the microorganisms on the stored seed product, thus enabling inoculation well in advance of planting while still preserving the full benefits of the inoculant, seed viability and seed plantability. This invention is directed to all types of planting seed.

In certain embodiments, a mixture including a starch and a sugar alcohol is combined with inoculants in an aqueous solution prior to seed treatment. In some of these embodiments, the mixture can be an aqueous formulation of a polysaccharide carbohydrate and a sugar alcohol that is supplied in sterile form. Alternatively, the starch and sugar alcohol can also first be provided in a dry formulation that is then mixed with water to form an aqueous mixture including a starch and a sugar alcohol, which is combined with inoculants. The inoculants can be provided in an aqueous form as well. In yet another alternative, a kit can also be provided in which there is (1) an aqueous mixture including a starch and a sugar alcohol, and (2) an aqueous solution with inoculants.

The polysaccharide carbohydrates in certain embodiments are an amylopectin starch from waxy maize or a hemicellulose. The sugar alcohols in certain embodiments can be sorbitol, mannitol, xylitol, maltitol, or mix combinations thereof. The mixture of a starch and a sugar alcohol in water can be sterilized, for example, either by irradiation or heat treatment. Alternatively, autoclaving may also be used to sterilize the foregoing aqueous mixtures of a starch and a sugar alcohol.

In certain embodiments of the invention, the starch in the mixture may help maintain microorganism stability due to its high, but relatively weak, binding affinity with water. Furthermore, due to its weak binding ability, this water-saturated gel provides hydration stability when it is applied onto seeds with rhizobial inoculants or inoculants of other beneficial microorganisms, thus allowing migration of water to the cells of the microorganisms. This increased stability allows sensitive bacteria, such as rhizobia, to more readily survive the rapid drying processes. The sugar alcohol can also enhance bacterial survival and acts as a binder to adhere the cells to the seed surface.

The addition of the seed coating aqueous mixture of this present invention to the seeds significantly increases the survival and/or viability of the co-applied microorganism inoculants. Additionally, the mixture may be supplied in sterile formulation, which further increases the survival and viability of the mixture. The mixture in certain embodiments is also biodegradable, which is environmentally advantageous.

### BRIEF DESCRIPTION OF THE DRAWINGS

FIG. 1 shows a comparison of the shelf-lives of liquid inoculants on soybean between a liquid rhizobial inoculant that is applied alone and a liquid rhizobial inoculant that has been treated with the present invention.

FIG. 2 shows the effect of the present invention on the survival and viability of the commercially available Nod+ rhizobial inoculant on stored soybean when compared with inoculants applied alone.

FIG. 3 shows the effect of the present invention on the survival and viability of the commercially available Apex Pro rhizobial inoculant on stored soybean when compared with inoculants applied alone.

FIG. 4 shows the effect of the present invention on the survival and viability of the commercially available Cell-Tech branded rhizobial inoculant on stored soybean when compared with inoculants applied alone.

FIG. 5 shows the effect of a fungicide on the survival and viability of rhizobial inoculants on stored soybean with and without the present invention.

FIG. 6 shows the effect of a fungicide on the survival and viability of rhizobial inoculants on stored soybean with and without the present invention.

FIG. 7 shows the effect of a fungicide on the survival and viability of rhizobial inoculants on stored soybean with and without the present invention.

FIG. 8 shows the effect of an insecticide on the survival and viability of rhizobial inoculants on stored soybean with and without the present invention.

### DETAILED DESCRIPTION OF SPECIFIC EMBODIMENTS

The present invention provides a seed coating that includes a polymer and a sugar alcohol. In certain embodiments of the present invention, the mixture includes two powdered constituents. In some of these embodiments, the mixture includes the two powdered constituents mixed in water. In one of these embodiments, both of the powdered constituents are soluble in water at ambient temperature. For example, the mixture can be an aqueous preparation of a polysaccharide carbohydrate and a sugar alcohol that is supplied in a sterile form either by irradiation or by formulation within a can or by other means of sterilization.

In certain embodiments of the present invention, the polysaccharide carbohydrate is a starch from waxy (i.e., high amylopectin) maize. In one such embodiment, this starch is a chemically modified food-grade starch powder refined from waxy maize, one such example of which is N-Tack® from National Starch—Food Innovation. In other embodiments, the polysaccharide carbohydrate is soluble cellulose, such as a hemicellulose.

In certain embodiments of the present invention, the sugar alcohol is sorbitol. In one of these embodiments, the sorbitol is in crystalline form. In other certain embodiments, the sugar alcohol is a mannitol, xylitol, maltitol, sorbitol, or combinations thereof.

In certain embodiments of the present invention, the liquid mixture is produced by mixing the powdered constituents with water. In one such embodiment, the liquid mixture has the following ratios by weight: seven parts polysaccharide carbohydrate, three parts sugar alcohol, and fifteen parts water. In other embodiments of the present invention, the liquid mixture has the following ratios by weight: approximately seven parts polysaccharide carbohydrate, approximately three parts sugar alcohol and two to thirty parts water.

In certain embodiments of the present invention, the water is weighed into a mixing vessel. In one such embodiment, the mixing vessel is equipped with a rotor mixer. The sugar alcohol is added to the water gradually, and the polysaccharide carbohydrate is then gradually mixed in until a uniform consistency is produced.

In certain embodiments of the present invention, the liquid mixture is sterilized. In one such embodiment, the liquid mixture is sterilized within a few days of the formation of the liquid mixture. In one of these embodiments, the liquid mixture is sterilized by irradiating the liquid mixture with gamma-irradiation. One of these embodiments uses irradiation dosage around fifteen kGy. In another embodiment, the liquid mixture is sterilized by heat sterilization methods. In still another embodiment, the liquid mixture is sterilized by autoclaving.

In certain embodiments of the present invention, the liquid mixture is sealed inside a container. In one of these embodiments, the liquid mixture is sealed inside the container prior to sterilization. The liquid mixture may then be stored. In certain embodiments of the present invention, the liquid mixture can be stored at room temperature. In certain embodiments, the liquid mixture is stored out of direct sunlight.

In certain embodiments of the present invention, the liquid mixture is mixed prior to applying the mixture on seeds. In certain embodiments of the present invention, the inoculants are added to the liquid mixture before application to the seed. Examples of inoculants that can be used in this invention include bacteria and rhizobia. In other embodiments, the inoculants are other bacteria, or fungi or other microorganisms that may be beneficial to plants.

In certain embodiments of the present invention, other inoculant formulations may be added to the mixture. In some of these embodiments, fungicides are added to the mixture. In other of these embodiments, insecticides are added to the mixture. In these embodiments, certain fungicide or insecticide formulations are Apron Maxx Bean Pak®, Soygard® L, or Warden RTA™, Cruiser Maxx® RFC for soybean. In other embodiments of the present invention, other formulations may be added by sequential application to the seeds.

In certain embodiments of the present invention, the mixture with the inoculants is applied to the seeds. In some of these embodiments, conventional seed treatment application equipment is used. In one such embodiment, a drum seed treater is used. In other embodiment, a batch seed treater is used. Some of these embodiments add the inoculant mixture by using slurry injection systems. Others of these embodiments add the inoculant mixture by using direct liquid injection systems.

In certain embodiments of the present invention, the coated seed is allowed to dry prior to planting.

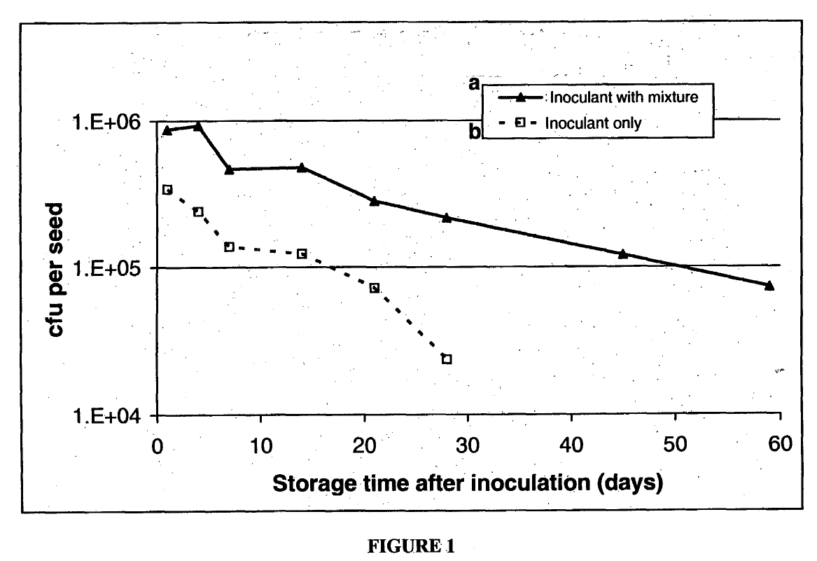

Typically, soybean seed-applied liquid rhizobial inoculants have an on-seed survival and/or viability of less than twenty days at efficacious levels (approximately 10⁶ cells per seed) when stored at ambient temperature. When co-applied with the mixture, this survival and viability is extended to over fifty days, a significant improvement (FIG. 1).

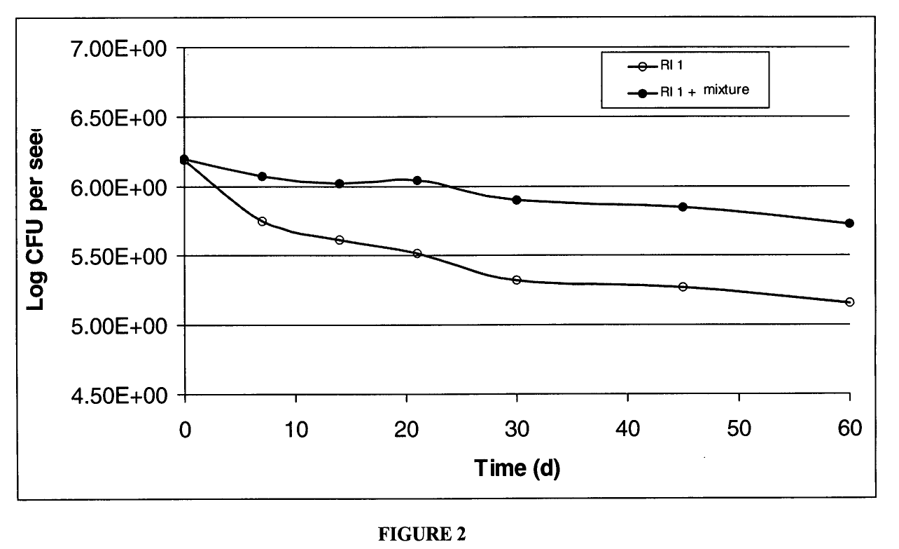

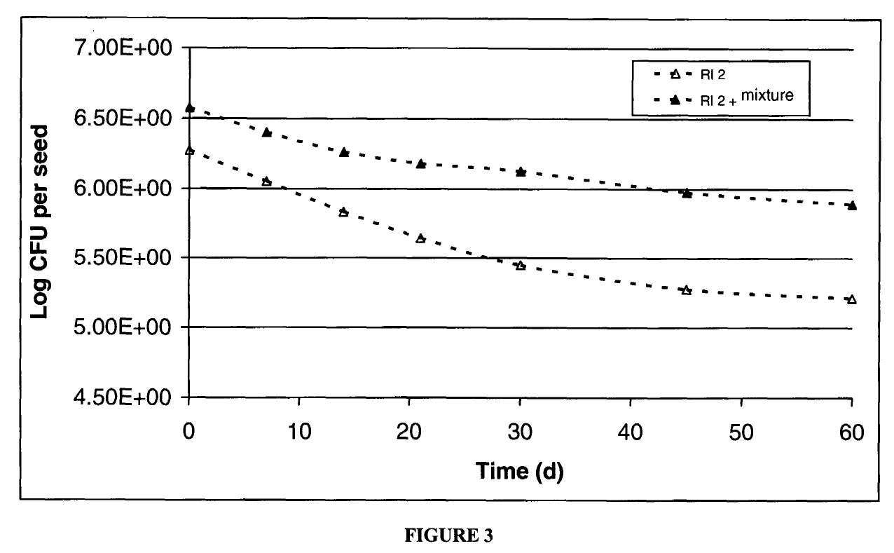

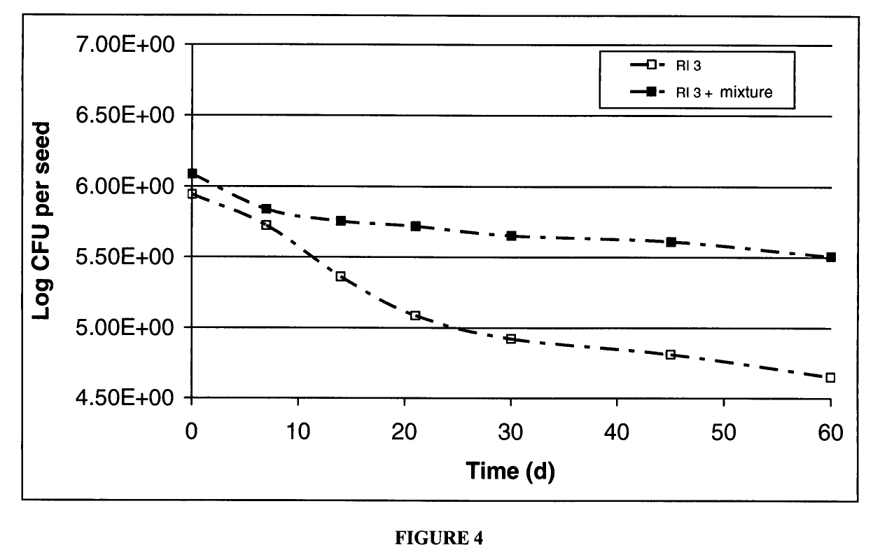

The mixture has been shown to have broad-spectrum compatibility with a range of rhizobial inoculants, showing significant survival increases on soybean when compared with inoculants applied alone (FIGS. 2-4).

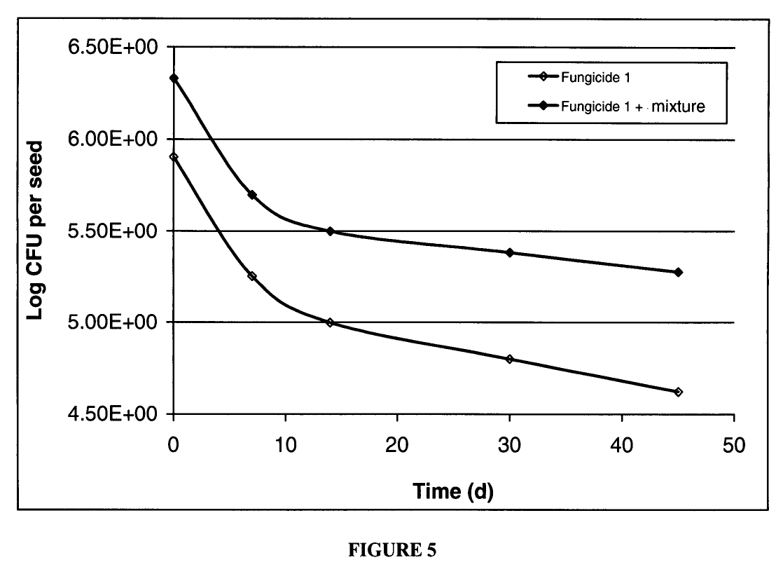

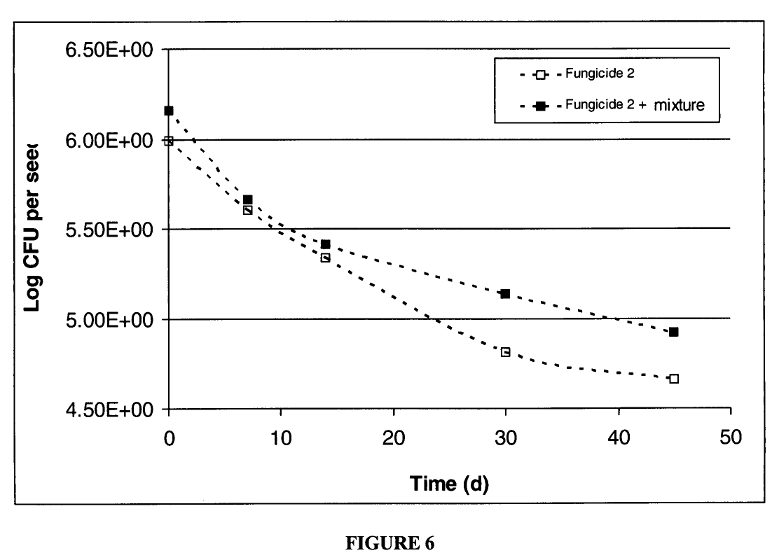

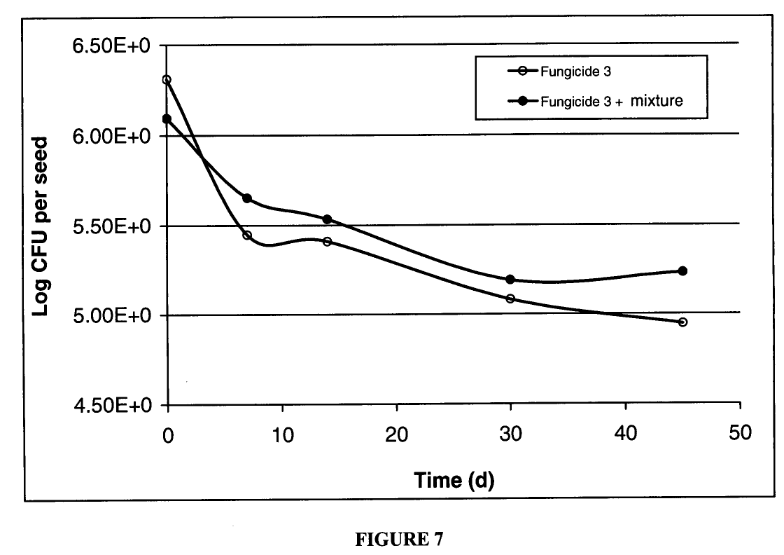

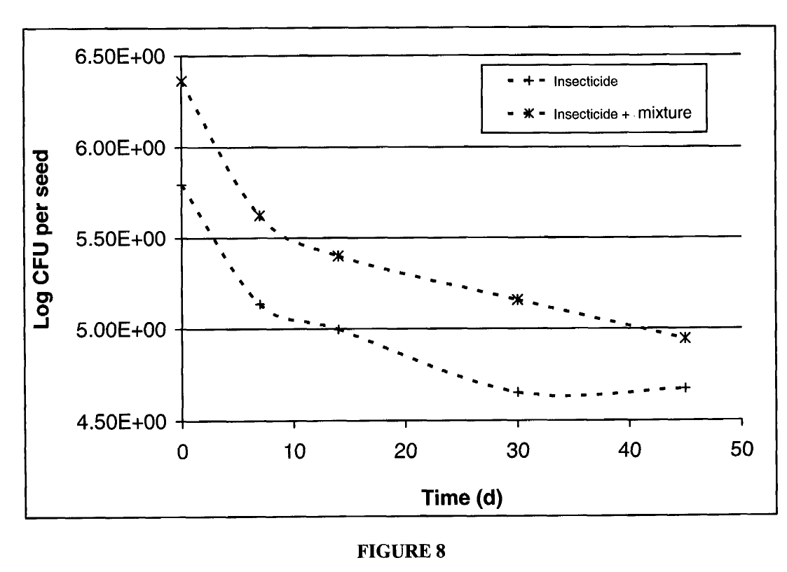

The mixture stabilizes or helps preserve the survival of rhizobial inoculants when co-inoculated on soybean with fungicides and insecticides used in standard soybean cropping practices (FIGS. 5-8).

The properties of the starch-sugar mixture therefore provide a novel coating environment that extend the survival and viability of rhizobia on seeds in dry storage and also confer a survival benefit in the presence of standard pesticide applications.

All of the apparatuses and methods disclosed and claimed herein can be made and executed without undue experimentation in light of the present disclosure. While the compositions and methods of this invention have been described in terms of embodiments, it will be apparent to those of skill in the art that variations may be applied to the compositions and/or methods and in the steps or in the sequence of steps of the methods described herein without departing from the concept, spirit and scope of the invention. More specifically, it will be apparent that certain agents that are chemically or physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed:

1. A mixture for coating seeds to improve the survival of microorganism inoculants applied to the seeds comprising a carbohydrate and a sugar alcohol.

2. A mixture of claim 1, wherein the mixture comprising the carbohydrate and the sugar alcohol is formulated as a sterile preparation.

3. The mixture of claim 2, wherein the mixture comprising the carbohydrate and the sugar alcohol is formulated as a sterile preparation by irradiation or within a can.

4. The mixture of claim 3, wherein the carbohydrate is a starch from waxy maize.

5. The mixture of claim 4, wherein the sugar alcohol is sorbitol.

6. The mixture of claim 4, wherein the sugar alcohol is selected from group consisting of sorbitol, mannitol, xylitol, maltitol, or combinations thereof.

7. A mixture for coating seeds to improve the survival of microorganism inoculants applied to the seeds comprising a mixture comprising a carbohydrate, a sugar alcohol and said microorganism inoculants.

8. The mixture of claim 7, wherein the mixture comprising the carbohydrate and the sugar alcohol is formulated as a sterile preparation.

9. The mixture of claim 8, wherein the mixture comprising the carbohydrate and the sugar alcohol is formulated as a sterile preparation by irradiation or within a can.

10. The mixture of claim 9, wherein the carbohydrate is a starch from waxy maize.

11. The mixture of claim 10, wherein the sugar alcohol is sorbitol.

12. The mixture of claims 7, 10, and 11, wherein the microorganisms are a nitrogen-fixing bacterium.

13. The mixture of claim 10, wherein the sugar alcohol is selected from group consisting of sorbitol, mannitol, xylitol, maltitol, or combinations thereof.

14. A method for improving the survival of microorganism inoculants on the seeds, comprising the step of coating seeds with a mixture comprising a carbohydrate, a sugar alcohol and microorganisms.

15. The method of claim 14, wherein the mixture comprising the carbohydrate and the sugar alcohol is formulated as a sterile preparation.

16. The method of claim 15, wherein the mixture comprising the carbohydrate and the sugar alcohol is formulated as a sterile preparation by irradiation or within a can.

17. The method of claim 16, wherein the carbohydrate is a starch from waxy maize.

18. The method of claim 17, wherein the sugar alcohol is sorbitol.

19. The method of claims 14, 17 and 18, wherein the microorganisms are a nitrogen-fixing bacterium.

20. A method for improving the survival of microorganism inoculants on the seeds, comprising the step of coating seeds with a aqueous mixture comprising a carbohydrate, a sugar alcohol and a aqueous mixture containing microorganism inoculants, and an insecticide or fungicide formulation.

21. A seed coated with a mixture comprising a carbohydrate, a sugar alcohol and microorganisms.

22. The seed of claim 21, wherein the mixture comprising the carbohydrate and the sugar alcohol is formulated as a sterile preparation.

23. The seed of claim 22, wherein the mixture comprising the carbohydrate and the sugar alcohol is formulated as a sterile preparation by irradiation or within a can.

24. The seed of claim 23, wherein the carbohydrate is a starch from waxy maize.

25. The seed of claim 24, wherein the sugar alcohol is sorbitol.

26. The seed of claims 21, 24 and 25, wherein the microorganisms are a nitrogen-fixing bacterium.

27. The seed of claims 21, 24 and 25, wherein the mixture is co-applied with an insecticide or fungicide formulation onto the seed.

28. The seed of claim 24, wherein the sugar alcohol is selected from group consisting of sorbitol, mannitol, xylitol, maltitol, or combinations thereof.

29. A dry mixture for addition to water for use in coating seeds to improve the survival of microorganism inoculants on the seeds, wherein such mixture comprises a carbohydrate and a sugar alcohol.

30. The dry mixture of claim 29, wherein the carbohydrate is a starch from waxy maize.

31. The dry mixture of claim 30, wherein the sugar alcohol is sorbitol.

32. The dry mixture of claim 30, wherein the sugar alcohol is selected from group consisting of sorbitol, mannitol, xylitol, maltitol, or combinations thereof.

33. A kit for coating seeds to improve the survival of the microorganism inoculants on the seeds comprising: (a) a mixture of a carbohydrate and a sugar alcohol, (b) a microorganism.

34. The kit of claim 33, wherein the mixture comprising a carbohydrate and a sugar alcohol is formulated as a sterile preparation.

35. The kit of claim 34, wherein the mixture comprising a carbohydrate and a sugar alcohol is formulated as a sterile preparation by irradiation or within a can.

36. The kit of claim 35, wherein the carbohydrate is a starch from waxy maize.

37. The kit of claim 35, wherein the sugar alcohol is sorbitol.

38. The kit of claims 33, 36, and 37, wherein the microorganisms are a nitrogen-fixing bacterium.

39. The kit of claims 33, 36, and 37, wherein the kit also includes an insecticide or fungicide formulation.

40. The kit of claim 36, wherein the sugar alcohol is selected from group consisting of sorbitol, mannitol, xylitol, maltitol, or combinations thereof.
